(19) United States
(12) Patent Application Publication
(10) Pub. No.: US 2020/0082373 A1
(43) Pub. Date: Mar. 12, 2020

(54) SYSTEM INCLUDING SHOPPING CART, MOBILE DEVICE, MOBILE APPLICATION TO FACILITATE SHOPPING AT A STORE, QR-CODED CREDIT CARD, AND MOBILE APPLICATION TO ORGANIZE SHOPPING DATA

(71) Applicant: Nazar Kozak, Hackettstown, NJ (US)

(72) Inventor: Nazar Kozak, Hackettstown, NJ (US)

(21) Appl. No.: 16/122,881

(22) Filed: Sep. 6, 2018

(51) Int. Cl. G06Q 20/20; G06Q 20/32; G06K 7/14; G06Q 30/06

(52) U.S. Cl. CPC G06Q 20/208; G06Q 30/0633; G06K 7/1417; G06Q 20/3276

(57) ABSTRACT

A shopping cart to communicate with a mobile device having a mobile application running thereon, the shopping cart including a main storage portion to receive an object therein, the main storage portion including a base upon which the object may be disposed, and a plurality of walls extending upwards from side portions of the base to form a space wherein the object may be held, a scanning unit disposed along a top portion of at least one of the plurality of walls to scan an identifying member disposed on the object, a processor disposed on the shopping cart to receive data from the scanning unit corresponding to the scanned object and to store the data within a storage unit of the processor, and a communication unit to send the data to the mobile device such that the user may use the mobile device to at least one of view the data corresponding to the scanned object and pay for the object.

### BACKGROUND

### 1. Field of the Invention

The present general inventive concept relates generally to a shopping cart, and particularly, to a shopping cart, mobile device, mobile application to facilitate shopping at a store, QR-coded credit card, and mobile application to organize shopping data.

### 2. Description of the Related Art

When customers go shopping, they often place their desired items in shopping carts in order to easily collect and store the items they intend to purchase. However, the customers are required to wait at check-out queues to actually purchase the items stored within their shopping carts. This is time consuming, as the check-out queues may often be long when there are not enough store employees at the cash registers. As such, the customers are forced to wait their turn.

Therefore, there is a need for a system to facilitate shopping at a store, in order to save time, money, and paper.

There is also a need for a system that allows users to easily view and organize their purchases.

### SUMMARY

The present general inventive concept provides a system including a shopping cart, mobile device, mobile application to facilitate shopping at a store, and mobile application to organize shopping data.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a shopping cart to communicate with a mobile device having a mobile application running thereon, the shopping cart including a main storage portion to receive an object therein, the main storage portion including a base upon which the object may be disposed, and a plurality of walls extending upwards from side portions of the base to form a space wherein the object may be held, a scanning unit disposed along a top portion of at least one of the plurality of walls to scan an identifying member disposed on the object, a processor disposed on the shopping cart to receive data from the scanning unit corresponding to the scanned object and to store the data within a storage unit of the processor, and a communication unit to send the data to the mobile device such that the user may use the mobile device to at least one of view the data corresponding to the scanned object and pay for the object.

The data may include at least one of a predetermined weight, a name, a price, and a picture of the scanned object.

The processor may create a list including the data corresponding to the scanned object and other data corresponding to other objects scanned by the scanning unit.

The base may include a scale disposed thereupon to sense a weight of the object placed within the main storage portion and to send the sensed weight to the processor.

The processor may compare the sensed weight of the object placed within the main storage portion with a predetermined weight of the object placed within the main storage portion, and to determine whether the object was correctly placed within the main storage portion. If the processor determines that the sensed weight of the object in the shopping cart is different from the predetermined weight of the object, the processor may determine that there has been an incorrect scan and sends a notification to the mobile device to delete the object from a total list of objects stored within the processor.

The shopping cart may further include a sensor to sense whether the shopping cart has exited a predetermined location, and to send a signal to the processor to alert a third party external device that the shopping cart has exited the predetermined location.

The shopping cart may further include an auxiliary scale disposed on the main storage portion to allow a user to weigh the object thereupon and to send the weight of the object to the processor, which stores the weight of the object in the storage device of the processor.

The mobile device may allow the user to input a name of the object weighed on the auxiliary scale to identify the object.

The foregoing and/or other features and utilities of the present general inventive concept may also be achieved by providing a system to facilitate shopping, including a server to store data regarding objects for sale within a particular store, a shopping cart to automatically scan at least one of the objects when the at least one of the objects is placed within the shopping cart, a mobile device having a mobile application running thereon to receive data regarding the scanned at least one of the objects and to allow a user to pay for the at least one of the objects using the mobile device, and a network to allow the server, the mobile device, and the shopping cart to communicate therebetween.

The foregoing and/or other features and utilities of the present general inventive concept may also be achieved by providing a system to organize shopping data, including a server to store data regarding objects for sale within a particular store, a credit card having a unique QR code, a mobile device having a mobile application running thereon to receive data regarding the scanned at least one of the objects and to allow a user to pay for the at least one of the objects using at least one of the mobile device and the credit card having the unique QR code, and a network to allow the server and the mobile device to communicate therebetween.

The foregoing and/or other features and utilities of the present general inventive concept may also be achieved by providing a system to organize shopping data, including a credit card having a unique QR code to store data regarding items purchased by a user using the QR code, a storage unit to store the data, and a mobile device having a mobile application running thereon to receive the data.

The system may further include a card reader to allow the user to purchase the items using the QR code by scanning the QR code.

The mobile device may recieve the data from the QR code after the card reader has scanned the QR code.

The QR code may be linked to a credit card profile of the user.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a block diagram of a system to facilitate shopping at a store, according to an exemplary embodiment of the present general inventive concept;

FIG. 2 illustrates a top angled side view of a shopping cart, according to an exemplary embodiment of the present general inventive concept;

FIG. 3 illustrates a top view of a shopping cart, according to an exemplary embodiment of the present general inventive concept; and

FIG. 4 illustrates a diagram of a system including a credit card, a credit card reader, a mobile device, a server, and a mobile application running on the mobile device to organize shopping data, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

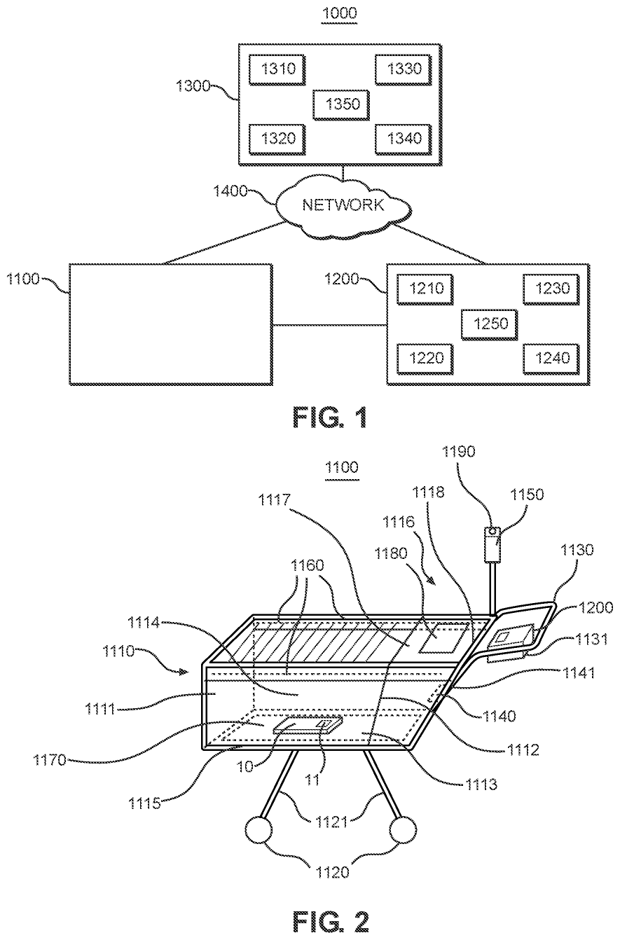

FIG. 1 illustrates a block diagram of a system to facilitate shopping at a store, according to an exemplary embodiment of the present general inventive concept.

The system 1000 may include a shopping cart 1100, a mobile device 1200, a server 1300, and a network 1400, but is not limited thereto.

The shopping cart 1100 may be any type of shopping cart known to one of ordinary skill in the art, and may be constructed from metal, plastic, wood, or any other material known to one of ordinary skill in the art.

FIG. 2 illustrates a top angled side view of the shopping cart 1100, according to an exemplary embodiment of the present general inventive concept.

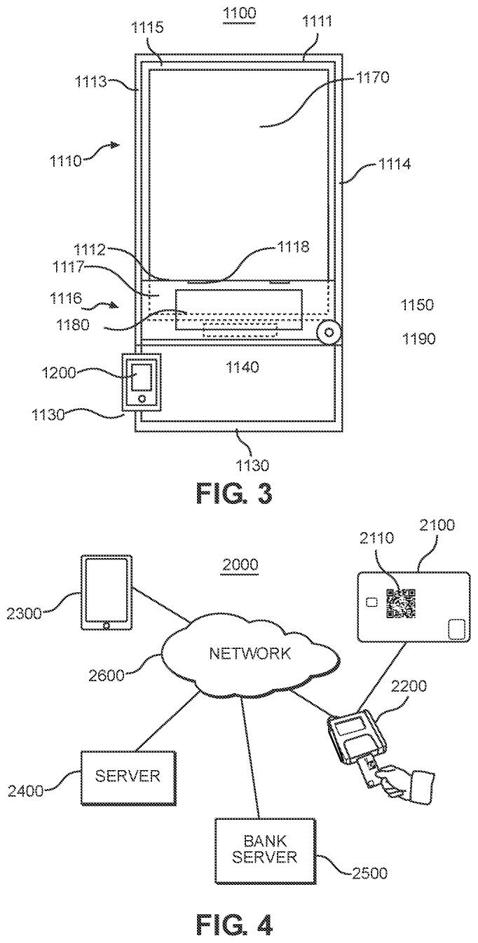

FIG. 3 illustrates a top view of the shopping cart 1100, according to an exemplary embodiment of the present general inventive concept.

Referring to FIGS. 1 through 3, the shopping cart 1100 may include a main storage portion 1110, a plurality of wheels 1120, a handle portion 1130, a processor 1140, a communication unit 1150, a scanning unit 1160, a scale 1170, an auxiliary scale 1180, and a sensor 1190.

The main storage portion 1110 may be a container created by a first wall 1111, a second wall 1112, a third wall 1113, a fourth wall 1114, and a base 1115. Specifically, the first wall 1111, the second wall 1112, the third wall 1113, and the fourth wall 1114 may extend vertically from the base 1115 to form the main storage portion 1110. More specifically, the base 1115 may be a surface upon which objects 10 may be disposed, and the first wall 1111, the second wall 1112, the third wall 1113, and the fourth wall 1114 upwards from side portions of the base 1115, thus creating a space wherein the objects 10 may be held.

The main storage portion 1110 may include an optional auxiliary storage portion 1116 that is separated from and smaller than the main storage portion 1110, and which may be located at a front portion of the main storage portion 1110, a side portion of the main storage portion 1110, or a rear portion of the main storage portion 1110.

The auxiliary storage portion 1116 may include a lid 1117 that may swing open from a front top portion of the auxiliary storage portion 1116 (as illustrated in FIG. 2), or alternatively, from rear top portions or side top portions of the auxiliary storage portion 1116, via a plurality of hinges 1118. Also, the auxiliary scale 1180 may be disposed on a top surface of the lid 1117, but is not limited thereto. Furthermore, the auxiliary scale 1180 may be a component that is connected to the main storage portion 1110, without necessitating the auxiliary storage portion 1116.

The plurality of wheels 1120 may include any number of wheels, such as two, three, or four, based on a user's preference, but not limited thereto. The plurality of wheels 1120 may be disposed at a bottom portion of the main storage portion 1110, specifically, below a bottom surface of the base 1115 (i.e., underneath the shopping card 1100), and may be attached to the main storage portion via a plurality of wheel attachment devices 1121. The wheel attachment devices may be pipes, rods, or any other type of attachment devices found on shopping carts known to one of ordinary skill in the art, which attach shopping cart wheels to a storage portion of a shopping cart.

The handle portion 1130 may be disposed at an upper-rear portion of the main storage portion 1110, and may be provided to allow the user to push and steer the shopping cart 1100 in a desired direction.

The handle portion 1130 may include a docking station 1131 that may allow any type of mobile device 1200 to be connected thereto, such that the mobile device 1200 may be connected to the processor 1140 via the docking station 1131, and may also have a battery thereof charged when connected to the docking station 1131.

The processor 1140 (or central processing unit, CPU) may be disposed at a rear portion of the shopping cart 1100, but is not limited thereto, and may alternatively be disposed at any portion and/or position on and/or along the shopping cart 1100. The processor 1140 may include electronic circuitry to carry out instructions of a computer program by performing basic arithmetic, logical, control and input/output (I/O) operations specified by the instructions. The processor 1140 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processor 1140 may also include a microprocessor and a microcontroller, and may control operations and interconnections between all components within the shopping cart 1100. Furthermore, the processor 1140 may include a storage unit 1141 to store data therein.

The communication unit 1150 may include a device capable of wireless or wired communication between other wireless or wired devices via at least one of Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The scanning unit 1160 may be a scanner connected to the processor 1140, and may include a barcode reader, a QR code reader, an RFID tag reader, a BLUETOOTH reader, a laser, a proximity sensor, and a sensor, but is not limited thereto. The scanning unit 1160 may also be connected and/or connectable to the Internet. The scanning unit 1160 may be hand-held or a larger stand-alone unit. The scanning unit 1160 may be disposed at a top portion of the main storage portion 1110, such that any item that enters into the main storage portion 1110 must first pass through the scanning unit 1160. Specifically, the scanning unit 1160 may include a plurality of laser scanners that emit non-harmful and invisible scanning lasers, for example, disposed along top portions of at least one of the plurality of walls, or alternatively, the third wall 1113 and the fourth wall 1114, for example, such that any object 10 entering the main storage portion 1110 must first pass through the scanning unit 1160.

Each time an object 10 enters the main storage portion 1110 of the shopping cart 1100, the scanning unit 1160 may sense that the object 10 has entered the main storage portion 1110, and may send a signal to the processor 1140 including data, such as a picture of the object 10, a name of the object 10, a weight of the object 10, and/or a price of the object 10. The processor 1140 may store the data corresponding to the object 10 in the storage unit 1141. As such, a list of the objects 10 scanned by the scanning unit 1160 may be stored within the storage unit 1141 of the processor 1140, and then accessed and/or viewed using the mobile device 1200. Here, the objects 10 may include any item on sale within a store, including, but not limited to, food, liquids, electronics, hardware, medicine, toys, clothes, shoes, artwork, utensils, books, magazines, supplies, appliances, or any other type of goods for purchase.

The scanning unit 1160 may actually sense an identifying mechanism 11 disposed on the objects 10. The identifying mechanisms 11 may include a barcode, a QR code, a RFID tag, a BLUETOOTH readable unit, and a sensor, but is not limited thereto. The identifying mechanism 11 may also be connected and/or connectable to the Internet.

The scale 1170 may be disposed at the base 1115 of the main storage portion 1110 (and connected to the processor 1140), and may send the weight and name of the object 10 to the processor such that a weight of the object 10 placed into the main storage portion 1110 may be calculated and monitored, such that the processor 1140 may compare a predicted (i.e., prederemined) weight of objects 10 in the shopping cart 1100 (based on a total cost of items scanned) to an actual weight of the objects 10 in the shopping cart 1100.

There may also be objects 10 placed within the cart that lack identifying mechanisms 11, so the scanning mechanism 1160 will not read that the objects 10 have been placed within the main storage portion 1110.

When an object 10 without an identifying mechanism 11, such as a fruit or a vegetable, enters the main storage portion 1110 without being scanned by the scanning unit 1160, the scale 1170 may sense that weight has been added to the main storage portion 1110, and the processor 1140 may control the communication unit 1150 to send a message to the mobile device 1200 to alert the user that the object 10 without the identifying mechanism 11 must first be weighed and processed as the proper fruit or vegetable before being placed into the main storage portion 1110.

Also, after the scale 1170 senses a weight of an object 10 placed within the main storage portion 1110 and sends the sensed weight to the processor 1140, the processor may compare the weight of the object 10 disposed on the scale to a predetermined weight of the object 10 scanned by the scanning unit 1160 to determine whether the object 10 was scanned properly.

Also, if the processor 1140 determines that the actual weight of the objects 10 in the shopping cart 1100 is different from the predicted weight based on items scanned, the processor 1140 may determine that there has been an incorrect scan, and the user may receive a notification on the mobile device 1200 to delete the object 10 from the total list of items (i.e., objects 10) stored within the processor 1140 based on the item's absence.

The auxiliary scale 1180 may be disposed on the main storage portion 1110, and may be provided to allow a user to weigh various items, such as fruits, vegetables, grains, etc., which are measured and sold by weight. Specifically, the auxiliary scale 1180 may be disposed on the lid 1117, but is not limited thereto. The auxiliary scale 1180 may be connected to the processor 1140, such that the processor 1140 may store a weight of the object 10 weighed on the auxiliary scale 1180 within the storage unit 1141.

The mobile device 1120 may allow the user to input a name of the object 10 weighed on the auxiliary scale to identify the object 10.

The sensor 1190 may be provided to sense whether the shopping cart 1100 has left and/or entered a predetermined vicinity and/or location, and may also sense whether the mobile device 1200 is in range of and/or attempting to communicate with the shopping cart 1100. In other words, the sensor 1190 may communicate with and/or interact with a sensor unit located at an entrance of a store, and may provide a signal to the processor 1140 that sends a signal to the communication unit 1150, which may then send a signal to the server 1130 to alert management that the shopping cart 1100 has left and/or entered the predetermined vicinity. In other words, the sensor 1190 may sense whether the shopping cart 1100 has exited a predetermined location, and may send a signal to the processor 1140 to alert a third party external device (such as a computing device used by management) that the shopping cart 1100 has exited the predetermined location.

The mobile device 1200 may include an input unit 1210, display unit 1220, a processor 1230, a communication unit 1240, and a storage unit 1250.

The mobile device 1200 may be any device that may access the network 1400 and communicate with other external mobile devices, including, but not limited to, a mobile telephone, a smart phone, a smart watch, a tablet computer, a laptop computer, a desktop computer, a card reader, etc.

The input unit 1210 may include a keyboard, a touchpad, a mouse, a trackball, a stylus, a voice recognition unit, a visual data reader, a camera, a wireless device reader, and a holographic input unit.

The input unit 1210 may be used to allow the user to choose to connect the mobile device 1200 to the shopping cart 1100 (using the mobile application executed on the mobile device 1200), and to allow instructions to be written from the processor 1140 of the shopping cart 1100 to connect to the processor 1230 of the mobile device 1200, such as whether to pay for items within the shopping cart 1100 using the input unit 1210.

The display unit 1220 may include a plasma screen, an LCD screen, a light emitting diode (LED) screen, an organic LED (OLED) screen, a computer monitor, a hologram output unit, a sound outputting unit, or any other type of device that visually or aurally displays data.

When an item is placed into the main storage portion 1110 of the shopping cart 1100, and as such, passes through the scanning unit 1160 of the shopping cart 1100, the item may be scanned and read by the scanning unit 1160, such that it is stored within either the storage unit 1141 of the processor 1140, the storage unit 1250, or the mobile application itself (i.e., within the server 1300). Also, when the item is placed into the main storage portion 1110 of the shopping cart 1100, and as such, passes through the scanning unit 1160 of the shopping cart 1100, the mobile application may allow the display unit 1220 to display a picture, a name, a weight, and/or a price of the object 10 that was scanned, as well as a list of other items that have already been scanned.

Therefore, the shopping cart 1100, the mobile device 1200, and/or the server 1300 may keep track of and/or monitor the items that have been scanned by the scanning unit 1160, and thus, may determine a final price that must be paid in order to purchase the items within the shopping cart 1100.

The processor 1230 (or central processing unit, CPU) may include electronic circuitry to carry out instructions of a computer program by performing basic arithmetic, logical, control and input/output (I/O) operations specified by the instructions. The processor 1230 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processor 1230 may also include a microprocessor and a microcontroller.

The communication unit 1240 may include a device capable of wireless or wired communication between other wireless or wired devices via at least one of Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 1250 may include a random access memory (RAM), a read-only memory (ROM), a hard disk, a flash drive, a database connected to the Internet, cloud-based storage, Internet-based storage, or any other type of storage unit.

The mobile device 1200 may receive the third data from another user's direct input into the input unit 1210 of the mobile device 1200. The third data may be stored in the storage unit 1250 of the mobile device 1200, and then sent to the server 1300 via the communication unit 1250 of the mobile device 1200. The third data may be analyzed by the server 1300 and then sent back to the mobile device 1200 to be displayed by the display unit 1220 of the mobile device 1200. All of the above actions may be controlled by the processor 1230 of the mobile device 1200.

Alternatively, the mobile device 1200 may be a part of the actual shopping cart 1100 attached permanently thereto, and may include all of the aforementioned components.

The server 1300 may include an input unit 1310, a display unit 1320, a processor 1330, a communication unit 1340, and a storage unit 1350.

The input unit 1310 may include a keyboard, a touchpad, a mouse, a trackball, a stylus, a voice recognition unit, a visual data reader, a camera, a wireless device reader, and a holographic input unit.

The display unit 1320 may include a plasma screen, an LCD screen, a light emitting diode (LED) screen, an organic LED (OLED) screen, a computer monitor, a hologram output unit, a sound outputting unit, or any other type of device that visually or aurally displays data.

The processor 1330 (or central processing unit, CPU) may include electronic circuitry to carry out instructions of a computer program by performing basic arithmetic, logical, control and input/output (I/O) operations specified by the instructions. The processor 1330 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processor 130 may also include a microprocessor and a microcontroller.

The communication unit 1340 may include a device capable of wireless or wired communication between other wireless or wired devices via at least one of Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The storage unit 1350 may include a random access memory (RAM), a read-only memory (ROM), a hard disk, a flash drive, a database connected to the Internet, cloud-based storage, Internet-based storage, or any other type of storage unit.

The storage unit 1350 of the server 1300 may store any and all information related to a store, including, but not limited to, items for sale at the store, prices of items for sale at the store, coupons related to the items for sale at the store, scanning information of the items, for sale at the store. In other words, the storage unit 1350 of the server 1300 may store all data related to and regarding objects 10 for sale within a particular store.

A user may input the above data via the input unit 1310 of the server 1300.

Communication between the shopping cart 1100, the mobile device 1200, and the server 1300 may occur via any type of wireless network 1400, including the Internet, an Intranet, intra-store connections, or inter-store connections. Even if the network 1400 is not functioning when commands and/or signals are sent between the shopping cart 1100, the mobile device 1200, and the server 1300, the network 1400 may send the commands and/or signals between the devices when the network 1400 is back online, or alternatively, via alternative communications such as Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

Any of the outputs generated by the server 1300 may be displayed on the display unit 1320 of the server 1300 or the display unit 1220 of the mobile device 1200. Likewise, any of the outputs generated by the mobile device 1200 may be displayed on the on the display unit 120 of the server 100 or the display unit 220 of the apparatus 200.

When the user has finished loading the shopping cart 1100 with all of the items/objects that the user wishes to purchase, the user may use the mobile device 1200, in conjunction with the mobile application, to view a final invoice denoting the a list and total cost of all the items/objects within the shopping cart 1100. The user may also use the mobile device 1200, in conjunction with the mobile application, in order to type in and/or scan a credit card (or access a linked bank account) to purchase the items.

The mobile application, the server 1300, and/or the mobile device 1200 may separately store various invoices and/or receipts regarding purchases at various stores within separate folders, in order to allow the user to keep track of and view items/objects that were purchased in the various stores.

The mobile application, the server 1300, and/or the mobile device 1200 may generate daily, weekly, monthly, quarterly, and/or yearly reports of money spent at each store, and an overall tally of the amount of total money spent.

The mobile application and/or the mobile device 1200 may allow the user to automatically check into the store as a member, in order to prevent a need for coupons or club cards to be collected and/or used. As such, users do not need to worry about missing out on deals, promotions, or coupons, as they will automatically be applied when the mobile device 1200 (having the mobile application executed thereon) is within the store. Also, the users may be alerted automatically if they have qualified for and/or won a store lottery, without having to check a paper receipt

The mobile application, the server 1300, and/or the mobile device 1200 may alert the user of various future deals, promotions, lotteries, and coupons at each store the user frequents.

The mobile application, the server 1300, and/or the mobile device 1200 may alert the user if the user's credit card has been used at a particular store without authorization, and then the user may use the mobile device 1200 and the mobile application to block the credit card immediately.

All alerts and messages may be sent directly to the mobile device 1200 via the mobile application, or alternatively, may be sent to an email account of the user to update the user regarding any information as mentioned above.

FIG. 4 illustrates a diagram of a system 2000 including a credit card 2100, a credit card reader 2200, a mobile device 2300, a server 2400, and a mobile application running on the mobile device 2300 to organize shopping data, according to an exemplary embodiment of the present general inventive concept.

The mobile application may be downloaded on the mobile device 2300.

The credit card 2100, the credit card reader 2200, the mobile device 2300, the server 2400, and a bank server 2500 may all communicate with each other via a network 2600. Communications may occur via any type of wireless network 2600, including the Internet, an Intranet, intra-store connections, or inter-store connections. Even if the network 2600 is not functioning when commands and/or signals are sent between the shopping credit card 2100, the credit card reader 2200, the mobile device 2300, the server 2400, and the bank server 2500, the network 2600 may send the commands and/or signals between the devices when the network 2600 is back online, or alternatively, via alternative communications such as W-Fi, W-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, and Ethernet.

The credit card 2100 may include a QR code 2110, which may be a unique code corresponding to each credit card 2100. The QR code 2110 may be scanned by the mobile device 2300, in order to allow the user to pay for any items scanned by the mobile device 2300 using the mobile device 2300.

The QR code 2110 may be linked to a credit card profile and/or a bank profile of the user. The QR code 2110 may also be synchronized with any and all servers described herein, and may also be synchronized and/or linked with the mobile application running on the mobile device 2300. As such, using the QR code 2110 may automatically allow the user to pay for items, store information regarding the items that were purchased, and access all profiles related to the user.

The QR code 2110 may also be used in conjunction with the credit card reader 2200, which may include a QR code reader therein, to read any items that may have been purchased by the credit card 2100. The credit card reader 2200 may allow the user to use the credit card 2100 to actually purchase the items scanned by the mobile device 2300 running the mobile application thereupon.

When the user purchases items using the QR code 2110, the QR code 2110 may store the items purchased, as well as the purchase price, to be accessed later by the mobile device 2300. In other words, the QR code 2110 saves and/or stores all of the purchase information for the user (e.g., in the cloud, a server, or a storage device), such that the user may later view the items purchased, purchase prices, and any other related information, on the mobile device 2300, which may be running the mobile application and/or program.

Also, the credit card reader 2200 may send information regarding purchases to the mobile application running on the mobile device 2300.

The mobile device 2300 may function similarly as the mobile device 1200 described above, and therefore, descriptions thereof will be omitted.

The server 2400 may function similarly as the server 1300 described above, and therefore, descriptions thereof will be omitted.

The bank server 2500 may be an external server at a bank where the user has an account, and may be linked to the credit card reader 2200, the mobile device 2300, the server 2400, and/or the mobile application running on the mobile device 2300.

The mobile device 2300 having running thereupon the mobile application to organize shopping data may have many optional functions, including, but not limited to, organizing all receipts according to stores where items were purchased in separate folders, displaying all purchased items, displaying how much money the user spent and/or saved each day/week/month/year, automatically checking into each store/shopping-center as a member upon entry of the user in the store/shopping-center, automatically applying all promotions/sales/coupons to the user's account upon entry into the store, automatically applying all future promotions/sales/coupons to the user's account upon entry into the store, automatically blocking a credit card associated with the mobile application if the credit card is stolen or lost, alerting the user via the mobile application if the credit card is stolen or lost, allowing the user an easy item-return feature, saving all receipts in the “cloud,” and automatically applying for various store giveaways/lotteries.

Alternatively, any of the above-mentioned information may be stored within the QR code 2110, and may be later viewable when the QR code 2110 is scanned and/or a mobile application and/or program corresponding to the QR code 2110 is accessed.

The system 2000 may be integrated with the system 1000, or may be separate therefrom. In other words, the system 1000 may also use the QR code 2110 of the credit card 2100 to store purchase information after items have been purchased in a store, such that a mobile device may be used to view and access information regarding the items that have been purchased, or any other related information as described above.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A shopping cart to communicate with a mobile device having a mobile application running thereon, the shopping cart comprising:
a main storage portion to receive an object therein, the main storage portion comprising:
a base upon which the object may be disposed, and
a plurality of walls extending upwards from side portions of the base to form a space wherein the object may be held;
a scanning unit disposed along a top portion of at least one of the plurality of walls to scan an identifying member disposed on the object;
a processor disposed on the shopping cart to receive data from the scanning unit corresponding to the scanned object and to store the data within a storage unit of the processor; and
a communication unit to send the data to the mobile device such that the user may use the mobile device to at least one of view the data corresponding to the scanned object and pay for the object.

2. The shopping cart of claim 1, wherein the data comprises at least one of a predetermined weight, a name, a price, and a picture of the scanned object.

3. The shopping cart of claim 1, wherein the processor creates a list including the data corresponding to the scanned object and other data corresponding to other objects scanned by the scanning unit.

4. The shopping cart of claim 1, wherein the base comprises:
a scale disposed thereupon to sense a weight of the object placed within the main storage portion and to send the sensed weight to the processor.

5. The shopping cart of claim 4, wherein the processor compares the sensed weight of the object placed within the main storage portion with a predetermined weight of the object placed within the main storage portion, and to determine whether the object was correctly placed within the main storage portion.

6. The shopping cart of claim 5, wherein if the processor determines that the sensed weight of the object in the shopping cart is different from the predetermined weight of the object, the processor determines that there has been an incorrect scan and sends a notification to the mobile device to delete the object from a total list of objects stored within the processor.

7. The shopping cart of claim 1, further comprising:
a sensor to sense whether the shopping cart has exited a predetermined location, and to send a signal to the processor to alert a third party external device that the shopping cart has exited the predetermined location.

8. The shopping cart of claim 1, further comprising:
an auxiliary scale disposed on the main storage portion to allow a user to weigh the object thereupon and to send the weight of the object to the processor, which stores the weight of the object in the storage device of the processor.

9. The shopping cart of claim 8, wherein the mobile device allows the user to input a name of the object weighed on the auxiliary scale to identify the object.

10. A system to facilitate shopping, comprising:
a server to store data regarding objects for sale within a particular store;
a shopping cart to automatically scan at least one of the objects when the at least one of the objects is placed within the shopping cart;
a mobile device having a mobile application running thereon to receive data regarding the scanned at least one of the objects and to allow a user to pay for the at least one of the objects using the mobile device; and
a network to allow the server, the mobile device, and the shopping cart to communicate therebetween.

11. A system to organize shopping data, comprising:
a credit card having a unique QR code to store data regarding items purchased by a user using the QR code;
a storage unit to store the data; and
a mobile device having a mobile application running thereon to receive the data.

12. The system of claim 11, further comprising:
a card reader to allow the user to purchase the items using the QR code by scanning the QR code.

13. The system of claim 12, wherein the mobile device receives the data from the QR code after the card reader has scanned the QR code.

14. The system of claim 11, wherein the QR code is linked to a credit card profile of the user.
